(19) United States
(12) Patent Application Publication
(10) Pub. No.: US 2002/0109052 A1
(43) Pub. Date: Aug. 15, 2002

(54) Column Unit

(76) Inventors: Young-Sang Jeon, Yesan-Kun (KR); In-Sun Jang, Kwanmyong-Si (KR)

Correspondence Address: McGuireWoods, 1750 Tysons Boulevard, Suite 1800, Tysons Corner, McLean, VA, 22102-4215, US

(21) Appl. No.: 09/861,540

(22) Filed: May 22, 2001

(30) Foreign Application Priority Data
Feb. 15, 2001 (KR) 2001-7525
Feb. 19, 2001 (KR) 2001-4114
Apr. 20, 2001 (KR) 2001-21272

(51) Int. Cl. F16M 11/00

(52) U.S. Cl. 248/161; 248/157; 248/125.8

(57) ABSTRACT

The present invention relates to a column unit which connects a chair sheet to a base in which a wheel is installed. The present invention provides a column unit which comprises a base tube having a lower end portion vertically fixed to a base of a chair and having the hollow interior; a spindle having the interior filled with a pressure gas and divided to upper and lower chambers by a piston, an upper end portion of a piston rod being connected to the piston, a lower end portion of the piston rod being rotatably installed at the lower end portion of the inner side of the base tube, the upper and lower chambers are communicated by a bypass, a valve being installed at the bypass; and a guide sleeve installed between the base tube and the spindle and engaged with the spindle to be integrally moved upward and downward together with the spindle.

### BACKGROUND OF THE INVENTION

1. Field of the Invention

The present invention relates to a column unit which connects a chair sheet to a base at which a wheel is installed, and more particularly to a column unit which is designed to regulate the height of a chair.

2. Description of the Prior Art

Generally, a known column unit applied to a chair has a structure in which a gas cylinder is installed in the interior of a base tub. A piston rod of the gas cylinder is rotatably installed at a support plate which seals the lower portion of the base tube by using a ball bearing. A piston installed at the end portion of the upper portion of the piston rod is located in the spindle of the gas cylinder. The interior of the spindle is filled with a pressure gas to perform the function of the gas cylinder. Even when the spindle is moved upward and downward along the piston rod, the pressure gas of the spindle is not discharged. The spindle is divided to upper and lower chambers by the piston. Holes are formed in the chambers to be connected by a bypass channel. A control valve and a control pin which controls the opening/closing operation of the valve are installed in the hole formed in the upper chamber. A chair sheet is positioned at the upper portion of the spindle. A chair base to which a wheel is conventionally mounted is installed at the lower portion of the base tube.

The column unit for a chair comprises the base tube and the gas spindle. The spindle of the gas cylinder is moved upward and downward to regulate the height of the chair sheet. When a user presses the control [pin to open the control valve in the state in which the spindle is located at the lowest position, the upper and lower chambers of the spindle are connected through the two holes and the bypass channel and the pressure gas in the spindle pushes the piston towards the lower position of the spindle to raise the spindle along the piston rod. To the contrary, if a force which exceeds the force of the pressure gas is applied from the upper portion of the spindle in the state in which the control pin is pressed, the spindle is moved downward. The user suitably can regulate the operation of the column unit to regulate the height of the chair sheet. The user can feel the cushion when the user is sat on the chair by the effect of the gas cylinder.

If the length of the piston rod is increased to increase the stroke of the spindle, the area by which the spindle and the tube guide makes contact with each other, i.e., the area by which the tube guide supports the spindle becomes smaller. In case a moment is applied to the upper portion of the spindle, the operation of the column unit becomes unstable or the base tube or the tube guide can be damaged by the load of the moment.

In order to settle the above-mentioned problems, a column unit for a chair is disclosed in U.S. Pat. No. 5,377,942. The patent installs a guide sleeve between the base tube and the spindle.

The patent installs a support ring which is moved upward and downward together with the spindle at the lower end portion of the spindle. An annular recess is formed in the interior of the guide sleeve from the lower side thereof to a predetermined height. If the support ring is raised as the spindle is raised and is caught by the upper end portion of the annular recess, the guide sleeve is raised together with the spindle from then. In case the spindle is moved downward to the lower side, the upper end portion of the guide sleeve is caught by another support ring installed in the spindle and is moved downward together with the spindle.

On the other hand, the patent discloses another preferred embodiment in which a guide sleeve is moved upward and downward together with a spindle by using a pulley and a pulley device.

According to the conventional column unit, in case the spindle is reciprocally moved, the frictional force between the outer surface of the spindle and the inner surface of the guide sleeve moves the spindle upward and downward or the frictional force is not sufficiently generated. As a result, in case two support rings installed at a predetermined position of the spindle and the upper end portion of the guide sleeve is raised, the upper end portion of an annular recess formed on the inner side thereof is moved upward and downward.

In case the frictional force is not sufficiently generated, after the support ring is caught at a predetermined position of the guide sleeve, the guide sleeve is moved. Therefore, in order to regulate the height only to the position, the guide sleeve is not raised and the guide sleeve cannot accomplish its function and the noise is generated when the support ring is caught.

Further, according to the conventional column unit, the number of parts is increased and thus the manufacturing cost is increased. And, the tolerances of the tube guide and the guide sleeve is simultaneously managed, and thus the inferiority rate is increased.

### SUMMARY OF THE INVENTION

The present invention has been made to solve the above-mentioned problem, and accordingly it is an object of the present invention to provide a column unit which has a guide sleeve which is integrally moved upward and downward together with a spindle when the guide sleeve guides and mechanically supports the spindle.

It is another object of the present invention to install a bushing installed at a position higher than a base tube on the outer surface of the spindle and to smoothly move the spindle upward and downward by supplying a lubricant to a portion at which the friction is generated.

It is another object of the present invention to prolong the life of the column unit by fitting an auxiliary metal pipe to a tube guide inserted into the base tube.

The present invention relates a column unit, and more particularly to a telescopic column unit which enables a spindle to performed a long stroke and smoothly accomplish the operation of the spindle. A guide sleeve is mounted to the outer surface of the spindle to integrally move upward and downward the spindle. A bushing coated with a lubricant is installed on the inner surface higher than the height of the base tube on the outer surface of the guide sleeve to guide the upward and downward movement of the spindle and the guide sleeve and supplement the mechanical supporting force. The damage of the tube guide is prevented by inserting the metal tube guide on the inner surface from the upper end of the base tube to prolong the life of the column unit.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is a view for showing a column unit according to the first preferred embodiment of the present invention at the minimum stroke position;

FIG. 2 is a view for showing the column unit of FIG. 1 at the maximum stroke position;

FIG. 3 is an enlarged view for showing the A portion shown in FIG. 2;

FIG. 4 is a perspective view for showing a bushing which is an element of the column unit according to the first preferred embodiment of the present invention;

FIG. 5 is a cross-sectional view taken along the line V-V shown in FIG. 4;

FIG. 6 is a view for showing a column unit according to the second preferred embodiment of the present invention at the minimum stroke position;

FIG. 7 is a view for showing the column unit of FIG. 6 at the maximum stroke position;

FIG. 8 is an enlarged view for showing the B portion shown in FIG. 7;

FIG. 9 is a perspective view for showing a bushing which is an element of the column unit according to the second preferred embodiment of the present invention; and

FIG. 10 is a cross-sectional view taken along the line X-X shown in FIG. 9.

### DETAILED DESCRIPTION OF THE PREFERRED EMBODIMENT

Hereinafter, preferred embodiments of the present invention will be explained in detail with reference to the attached drawings.

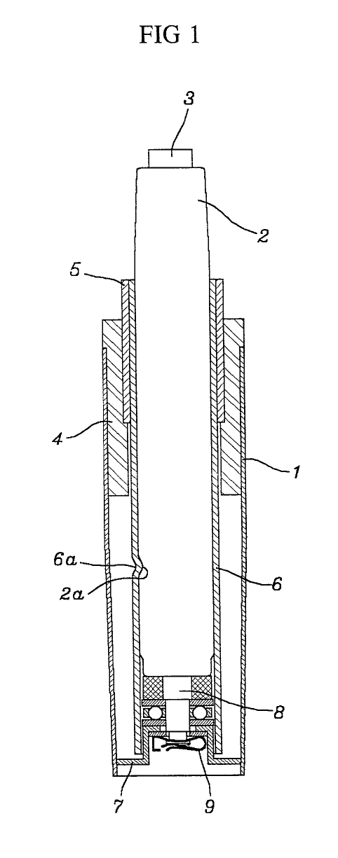

The first preferred embodiment of a column unit according to the present invention is shown in FIGS. 1 to 5. As shown in the figures, the column unit according to the present invention is installed vertically at a base of a chair at which a wheel is installed. A spindle 2 is installed at a cylindrical base tube (1) which has a cavity at the central portion of the column unit.

The interior of the spindle 2 is filled with a pressure gas. The spindle 2 is divided into upper and lower chambers by a piston. The piston is connected to a piston rod 8 the lower end of which is rotatably connected to a supporter 7. The supporter 7 is fixed to the lower end portion of the inner side of the base tube 1 by welding. A bearing is installed at the lower end portion of the piston rod 8 so that the spindle 2 is rotated. The upper and lower chambers of the spindle 2 are communicated by a bypass which connects the chambers. A valve is installed at a predetermined position of the bypass, and is operated by a gas opening/closing pin 3.

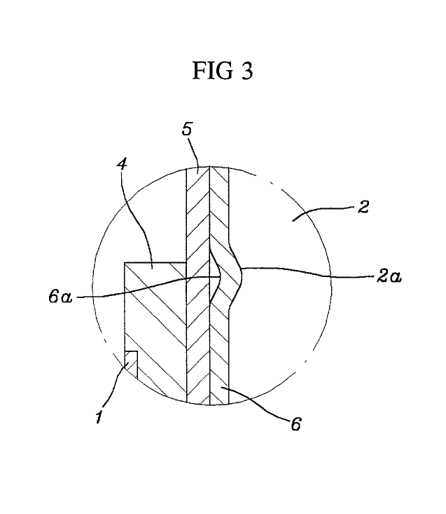

A cylindrical guide sleeve 6 having opened upper and lower portions is mounted to the outer surface of the spindle 2 by press-fitting. As shown in FIG. 3, in the state the spindle 2 is mounted to the inner surface of the guide sleeve 6, the guide sleeve 6 and the spindle 2 are struck by a strike to be recessed so that recessed portions 2a and 6a are formed. Therefore, when the spindle 2 is moved upward and downward, the guide sleeve 6 is integrally moved upward and downward.

The guide sleeve 6 is extended downwardly further than the lower end portion of the spindle 2 to increase the height of the spindle in the maximum stroke and to endure the moment applied at the upper end portion of the spindle 2.

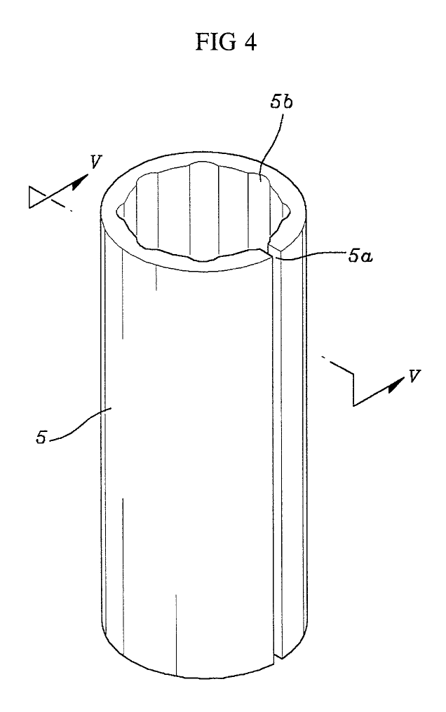

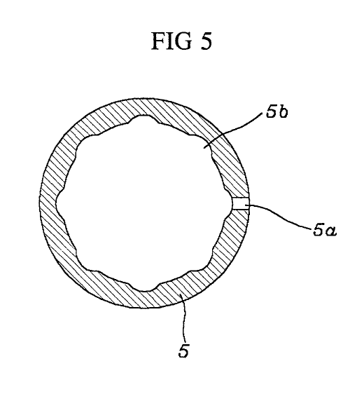

A cylindrical bushing 5 having opened upper and lower portions is installed on the outer surface of the guide sleeve 6. The bushing 5 guides the upward and downward movements of the spindle 2 like the guide sleeve 6, and provides a support force which can endures the moment applied at the upper end of the spindle 2 at the maximum strike position of the column unit. Therefore, even if the force applied to the spindle 2 is not applied vertically when the spindle 2 starts to move downwardly at the maximum stroke position, the spindle 2 is easily moved downward by the guide of the bushing 5. Further, since a lubricant is coated on the inner surface of the bushing 5, the spindle 2 is easily moved upward and downward. As shown in FIGS. 4 and 5, since a recess Sb is formed on the inner surface of the bushing 5, the frictional area is reduced and the spindle 2 is easily moved upward and downward. The recess 5b formed on the inner surface of the bushing 5 shown in FIGS. 4 and 5 is formed by using a circumference shape in the inner side arc.

MoS₂ or polyetraflourethylent is used as the lubricant coated on the inner surface of the bushing 5. The thickness of the lubricant is preferably 2 to 70 μm. The grease is supplied into the recess 5b formed on the inner surface of the bushing 5 to improve the lubricating effect.

In FIGS. 4 and 5, a cutting portion 5a is formed in the axial direction of the bushing 5 to facilitate the insertion when the bushing 5 is assembled.

A tube guide 4 is installed between the outer surface of the bushing 5 and the base tube 1.

According to the column unit of the first preferred embodiment of the present invention, if a user presses a gas opening/closing pin 3 at the minimum stroke position shown in FIG. 1, the upper and lower chambers divided by the piston is communicated through the bypass as the valve is opened. And, the piston is pushed downward by the gas pressure of the interior of the spindle 2 to raise the spindle 2.

If the force which presses the gas opening/closing pin 3 is removed when the spindle 2 is raised, the movement of the spindle 2 is stopped and the height of a chair sheet can be regulated. According to the present invention, as the guide sleeve 6 is raised together with the spindle 2 since the spindle 2 is initially raised, even when the spindle 2 is stopped after the spindle 2 is raised by a small distance, the guide sleeve 6 is stopped. Of course, the frictional force between the guide sleeve 6 and the bushing 5 is remarkably reduced by the operations of the bushing 5 and the lubricant to smoothly accomplish the operation of the guide sleeve.

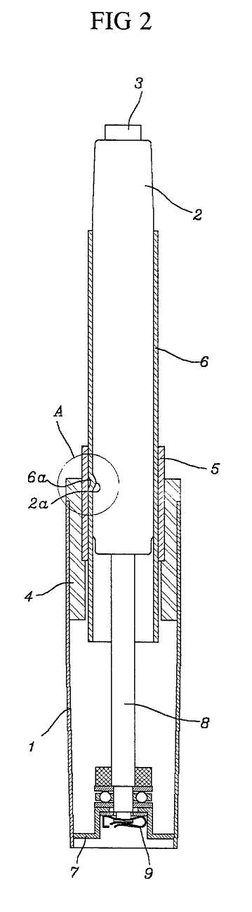

If the spindle 2 is raised further, it reaches the maximum stroke position as shown in FIG. 2, the spindle 2 and the guide sleeve 6 is integrally raised. Therefore, the longer stroke is more stably performed than the case in which the guide sleeve 6 is not provided.

In the above-mentioned state, if the user presses the gas opening/closing pin 3 and a force which can endure the gas pressure of the interior of the spindle 2 is applied, the spindle 2 is moved downward together with the guide sleeve 6. Then, if the force applied in the lower direction is vertically applied accurately, the spindle 2 and the guide sleeve 6 is smoothly moved downward. However, since a person sitting on the chair applies the force by using the weight of the person, the force is not vertically applied accurately and makes a predetermined angle with respect to the vertical line. For the reason, since conventionally an excessive stress is applied to a portion which makes contact with the guide sleeve 6 and the frictional force is increased, the spindle 2 and the guide sleeve 6 is not smoothly moved downward. However, according to the column unit of the present invention, since the bushing 5 is protruded to a predetermined height from the upper portion of the base tube 1, the spindle is moved downward by the guide of the bushing 5. Further, since the lubricant is coated on the inner surface of the bushing 5 and a plurality of recesses 5b for reducing the frictional area is formed, the spindle 2 and the guide sleeve 2 is more smoothly moved downward.

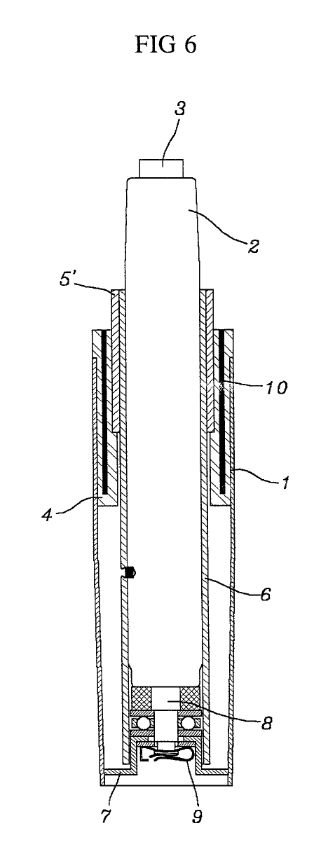

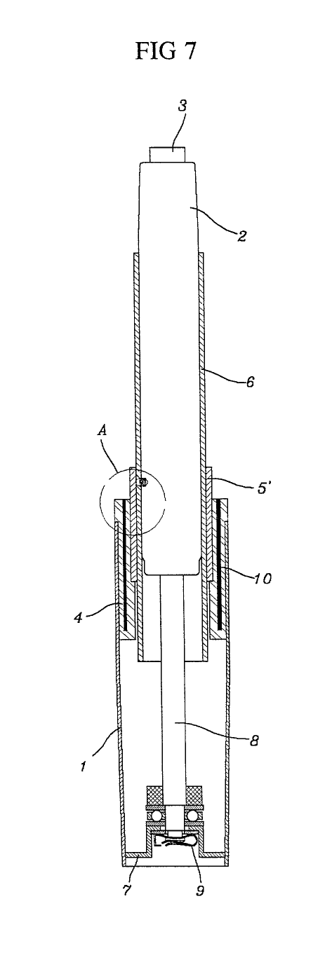

On the other hand, a column unit according to the second preferred embodiment of the present invention is shown in FIGS. 6 to 10. The second preferred embodiment of the present invention differs from the first preferred embodiment of the present invention in that an auxiliary pipe 10 made of a metal is inserted into the tube guide 4.

According to the column unit of the second preferred embodiment of the present invention, a through-hole 6b into which a screw 11 is engaged is formed in the guide sleeve 6 so that the guide sleeve 6 is moved together with the spindle 2. A screw recess 2b is formed in the spindle 2 so that the screw 11 is inserted into the screw recess 2b. After the screw 11 is engaged with the though-hole 6b and the screw recess 2b, the inlet portion of the through-hole 6b is collapsed by a stroke to prevent the separation of the screw.

According to the column unit of the second preferred embodiment of the present invention, the shape of a recess 5b′ of a bushing 5′ installed between the guide sleeve 6 and the tube guide 4 differs from the first preferred embodiment of the present invention.

The operation of the column unit according to the second preferred embodiment of the present invention is the same as that of the first preferred embodiment.

Namely, since the guide sleeve 6 is integrally moved upward and downward together with the spindle 2, the guide sleeve 6 effectively performs the guiding and supporting. Further, the bushing 5′ is installed to smoothly move the spindle 2 upward and downward.

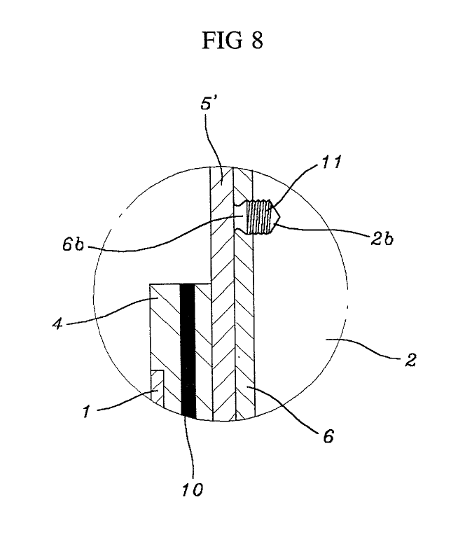

FIG. 8 is a view for showing in detain a structure by which the spindle 2 and the guide sleeve 6 are integrally moved upward and downward. As shown in the figure, the screw 11 is passed through the penetrating hole 6b formed in the guide sleeve 6 and is engaged with the screw recess 2b of the spindle 2. The inlet portion of the penetrating hole 6b is collapsed after the screw 11 is engaged with the penetrating hole 6b.

In the preferred embodiment, the screw 11 is engaged with the penetrating hole 6b and the screw recess 2b, but a pin of a predetermined length can be used.

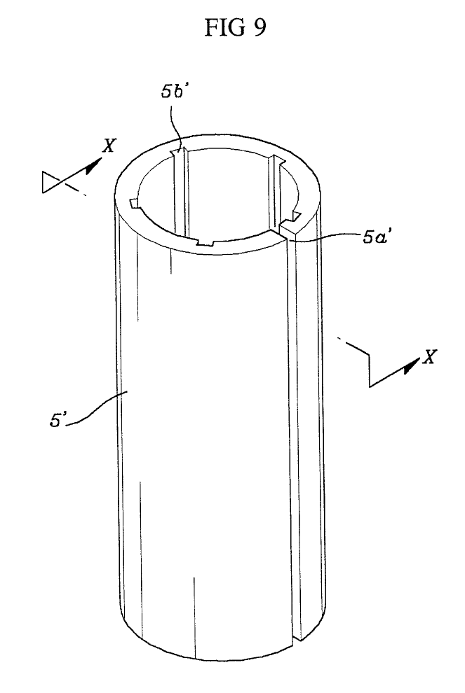

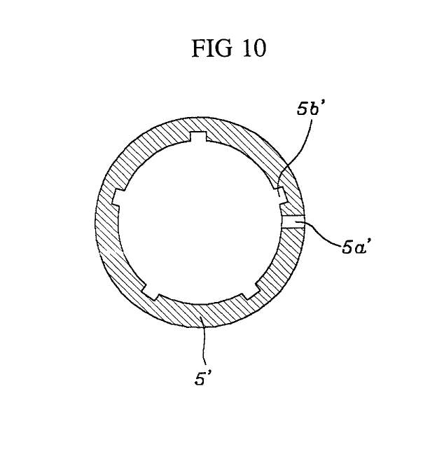

FIGS. 9 and 10 are views for showing the bushing 5′ of the column unit according to the second preferred embodiment of the present invention. A cutting portion 5a′ having a portion cut off along the axial direction to facilitate the assembling is formed in the bushing 5′. A long recess 5b′ is formed along the axial direction of the bushing on the inner side of the bushing. It is preferable that the inner surface of the bushing 5′ is coated with a lubricant and the grease is filled in the recesses 5b′.

As stated above, preferred embodiments of the present invention are shown and described. Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A column unit comprising:
a base tube having a lower end portion vertically fixed to a base of a chair and having the hollow interior;
a spindle having the interior filled with a pressure gas and divided to upper and lower chambers by a piston, an upper end portion of a piston rod being connected to the piston, a lower end portion of the piston rod being rotatably installed at the lower end portion of the inner side of the base tube, the upper and lower chambers are communicated by a bypass, a valve being installed at the bypass; and
a guide sleeve installed between the base tube and the spindle and engaged with the spindle to be integrally moved upward and downward together with the spindle.

2. A column unit according to claim 1, wherein the spindle is press-fitted to the interior of the guide sleeve so that the guide sleeve is integrally moved upward and downward together with the spindle.

3. A column unit according to claim 1, wherein the spindle is integrally moved upward and downward together with the guide sleeve by pressing a portion of the spindle by a strike in the state the spindle is inserted into the guide sleeve.

4. A column unit according to claim 1, wherein a penetrating hole is formed at a predetermined position in the state the spindle is inserted into the guide sleeve, and a recess is formed at a position of the spindle corresponding to the penetrating hole and a screw is inserted through the penetrating hole into the recess to be engaged so that the spindle is integrally moved together with the spindle.

5. A column unit according to claim 4, wherein a pin is used instead of the screw.

6. A column unit according to claim 4 or 5, wherein in the state the screw or the pin is passed through the penetrating hole and is completely engaged with the recess, the inlet portion of the penetrating hole is pressed inside to form a catching jaw so that the screw or the pin is not separated.

7. A column unit according to claim 1, wherein the lower end portion of the piston rod is rotatably installed at a rod supporter, and the supporter has a hat shape.

8. A column unit comprising:
a base tube having a lower end portion vertically fixed to a base of a chair and having the hollow interior;
a spindle having the interior filled with a pressure gas and divided to upper and lower chambers by a piston, an upper end portion of a piston rod being connected to the piston, a lower end portion of the piston rod being rotatably installed at the lower end portion of the inner side of the base tube, the upper and lower chambers are communicated by a bypass, a valve being installed at the bypass; and
a tube guide inserted between the base tube and the spindle and having a recess into which a cylindrical member is inserted and into which an auxiliary pipe is inserted.

9. A column unit according to claim 8, wherein the tube guide is made of a plastic and the auxiliary pipe is made of a metal.

10. A column unit according to claim 8, wherein a guide sleeve moved upward and downward together with the spindle is provided between the spindle and the tube guide.

11. A column unit comprising:
a base tube having a lower end portion vertically fixed to a base of a chair and having the hollow interior;
a spindle having the interior filled with a pressure gas and divided to upper and lower chambers by a piston, an upper end portion of a piston rod being connected to the piston, a lower end portion of the piston rod being rotatably installed at the lower end portion of the inner side of the base tube, the upper and lower chambers are communicated by a bypass, a valve being installed at the bypass; and
a bushing fixed between the base tube and the spindle and installed at a position higher than the base tube.

12. A column unit according to claim 11, wherein the inner surface of the bushing is coated with a lubricant.

13. A column unit according to claim 12, wherein the lubricant is MoS₂ or polyetraflourethylene.

14. A column unit according to claim 12, wherein the thickness of the lubricant is 2 to 70 μm.

15. A column unit according to claim 11, wherein the bushing has a cutting portion which is cut off along the axial direction so that the bushing is easily installed in the interior of the base tube.

16. A column unit according to claim 11, wherein at least one recess is formed along the axial direction of the bushing on the inner side of the bushing so that the frictional area with the spindle is reduced.

17. A column unit according to claim 16, wherein in case the long recess is plurally formed, the long recesses are regularly formed at a predetermined angle.

18. A column unit according to claim 16, wherein grease is filled in the long recess.

19. A column unit according to claim 11, wherein the bushing is manufactured by drawing.
